(19) United States
(12) Patent Application Publication
(10) Pub. No.: US 2007/0013616 A1
(43) Pub. Date: Jan. 18, 2007

(54) Plasma display apparatus and driving method thereof

(75) Inventors: Yunkwon Jung, Gumi-si (KR); Gun Su Kim, Seongnam-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/328,100

(22) Filed: Jan. 10, 2006

(30) Foreign Application Priority Data
Jul. 15, 2005 (KR) 10-2005-0064045

(51) Int. Cl. G09G 3/28

(52) U.S. Cl. 345/67

(57) ABSTRACT

The present invention relates to a plasma display apparatus, and more particularly to a plasma display apparatus and a driving method thereof, which are capable of preventing an afterimage-generating wrong discharge when a plasma display panel is driven. Provided is a plasma display apparatus, including: a plasma display panel on which a plurality of sustain electrode pairs, each including a scan electrode and a sustain electrode, are formed; a driver driving each sustain electrode pair; and a driving pulse controller which controls the driver to sequentially apply a first falling waveform and a second falling waveform to the scan electrode and to apply a positive waveform to the sustain electrode while applying the first falling waveform, in a reset period. In accordance with the present invention, it is possible to prevent afterimage-generating woring discharge by improving the structure of a plasma display apparatus and a driving method thereof. In accordance with the present invention, it is possbiel to prevent spots from being created on a displayed single color pattern by improving the structure of a plasma display apparatus and a driving method thereof.

This Nonprovisional application claims priority under 35 U.S.C. § 119(a) on Patent Application No. 10-2005-0064045 filed in Korea on Jul. 15, 2005, the entire contents of which are hereby incorporated by reference.

### BACKGROUND OF THE INVENTION

1. Field of the Invention

The present invention relates to a plasma display apparatus, and more particularly, to a plasma display apparatus which is capable of preventing an afterimage-generating wrong discharge from occurring when a plasma display panel is driven.

2. Description of the Background Art

In general, a plasma display apparatus includes a plasma display panel in which barrier ribs formed between a front substrate and a rear substrate partition unit cells. Main discharge gas, such as Ne, He, or He−Xe mixture (He+Xe), and inert gas containing a small amount of Xe are filled in each cell. When a discharge is performed by a high-frequency voltage, the inert gas generates vacuum ultraviolet rays and excites phosphors formed between the barrier ribs, thereby forming an image. Such a plasma display apparatus is coming into the spotlight as a next-generation display apparatus since it can be manufactured to be thin in thickness and light in weight.

FIG. 1 is a perspective view of a conventional plasma display panel.

As shown in FIG. 1, in the plasma display panel, a front panel 100 including a front substrate 101 on which images are displayed and a plurality of sustain electrode pairs, each consisting of a scan electrode 102 and sustain electrode 103, are arranged, is coupled with a predetermined distance in parallel with a rear panel 110 including a rear substrate 111 on which a plurality of address electrodes are arranged in a manner to intersect the plurality of sustain electrode pairs.

In the front panel 100, the scan electrode 102 and the sustain electrode 103 are arranged in pair, which are respectively used for discharging each discharge cell and for maintaining the luminescence of the discharge cell. Each of the scan electrode 102 and the sustain electrode 103 is composed of a transparent electrode a made of a transparent material, such as Indium-Tin-Oxide (ITO), and a bus electrode b made of a metal material. At least one dielectric layer 104 for limiting a discharge current and isolating the electrode pairs is formed to cover the scan electrode 102 and the sustain electrode 103. A protection layer 105 (for example, a MgO layer) for facilitating a discharge is formed on the dielectric layer 104.

In the rear panel 110, barrier ribs are arranged in a stripe type (or in a well type) to form a plurality of discharge spaces, that is, a plurality of discharge cells, and also at least one address electrode 113 for performing an address discharge to enable inert gas in each discharge cell to generate vacuum ultraviolet rays is formed parallel to the barrier ribs. Phosphors 114 of Red (R), Green (G), and Blue (B) for emitting visible rays and displaying an image when a sustain discharge is performed are formed on the upper surface of the rear panel 110. A dielectric layer 115 for protecting the address electrode 113 is inserted between the address electrode 113 and the phosphors 114.

The plasma display panel with the structure described above is driven by a driving apparatus (not shown) including driving circuits for supplying predetermined pulses to a plurality of discharge cells which are formed in a matrix structure.

FIG. 2 is a view for explaining an image forming method used in the conventional plasma display apparatus.

As shown in FIG. 2, the plasma display apparatus divides a frame period into a plurality of subfields with different numbers of discharges and emits light on a plasma display panel during a subfield period corresponding to a gray-level of an input image signal, thereby forming an image.

Each subfield is divided into a reset period for performing a uniform discharge, an address period for selecting discharge cells, and a sustain period for representing a gray-level according to the number of discharges. For example, in order to display an image in 256 gray-levels, a frame period (16.67 ms) corresponding to 1/60 second is divided into 8 subfields.

Each of the 8 subfields is divided to a reset period, an address period, and a sustain period. Here, the durations of the sustain periods of the 8 subfields sequentially increase at a rate of 2ⁿ (n=0, 1, 2, 3, 4, 5, 6, 7). As such, since the sustain periods of the respective subfields are different from each other, it is possible to represent a gray-level of an image.

Now, a driving method of the plasma display apparatus will be described with reference to FIGS. 3A and 3B.

FIG. 3A shows timing diagrams illustrating driving waveforms which are used in the conventional plasma display apparatus.

As shown in FIG. 3A, the plasma display apparatus is driven according to a reset period for initializing all cells, an address period for selecting cells to be discharged, a sustain period for sustain-discharging the selected cells, and an erase period for erasing wall charges in the discharged cells.

In the reset period, a set-up waveform Ramp-up of a rising ramp pulse is applied simultaneously to all scan electrodes during a set-up period. Thus, a weak dark discharge (set-up discharge) occurs in all discharge cells on the entire screen by the set-up waveform. Due to the set-up discharge, positive wall charges are accumulated on address electrodes and sustain electrodes and negative wall charges are accumulated on the scan electrodes.

After the set-up waveform is applied, during a set-down period, a set-down waveform Ramp-down of a falling ramp pulse falling from a voltage level lower than the maximum voltage level of the set-up discharge to a predetermined negative voltage level, is applied. The set-down waveform generates a weak erase discharge (set-down discharge) in the cells to thus sufficiently erase wall charges excessively formed on the scan electrodes. Due to the set-down discharge, the amount of wall charges which is sufficient to stably perform the following address discharge remains uniform in the discharge cells.

In the address period, a negative scan waveform is sequentially supplied to the scan electrodes and simultaneously a positive address waveform is applied to the address electrodes in synchronization with the scan waveform. A potential difference between the scan waveform and the address waveform is added with a wall voltage created during the reset period, so that an address discharge occurs in discharge cells to which the address waveform is applied. In cells selected by the address discharge, the amount of wall charges which is sufficient to occur a sustain discharge when a sustain waveform is applied, is formed. In the address period, a positive bias voltage V_{zb} is applied to the sustain electrodes during the address period, so as to reduce a potential difference between the sustain electrodes and the scan electrodes and thus prevent a wrong discharge from occurring between the sustain electrodes and the scan electrodes.

In the sustain period, a positive sustain waveform Sus is alternately applied to the scan electrodes and the sustain electrodes. In the cells selected by the address discharge, the wall voltage in the cells is added with the sustain waveform, so that a sustain discharge, that is, a display discharge occurs between the scan electrodes and the sustain electrodes whenever a sustain waveform is applied.

After the sustain discharge is complete, in the erase period, an erase waveform Ramp-ers having a narrow pulse width and a low voltage level is applied to the sustain electrodes, thus erasing wall charges remaining in all cells on the entire screen.

Wall charge distributions of discharge cells by the driving waveforms are shown in FIG. 3B.

FIG. 3B is a view for explaining wall charge distributions of discharge cells by the conventional driving waveforms.

Referring to FIG. 3B, during a set-up period of a reset period, a set-up waveform is applied to a scan electrode Y and a voltage waveform relatively lower than the set-up waveform is applied to a sustain electrode Z and an address electrodes X, so that negative charged particles are accumulated on the scan electrode Y as shown in (a) of FIG. 3B and positive charged particles are accumulated on the sustain electrode Z and the address electrode X.

Thereafter, during a set-down period, a set-down waveform is supplied to the scan electrode Y and a predetermined bias voltage, preferably, a ground (GND) voltage is supplied and sustained to the sustain electrode Z and the address electrode X, so to partially erase wall charges excessively accumulated in discharge cells during the set-up period in (b) of FIG. 3B. Due to the erasing process, wall charges are uniformly distributed in discharge cells.

Then, in an address period, an address discharge occurs by a scan waveform applied to the scan electrode Y and an address waveform applied to the address electrode X, as shown in (c) of FIG. 3B.

Thereafter, in a sustain period, a sustain waveform is applied alternately to the scan electrode Y and the sustain electrode Z, so that a sustain discharge occurs as shown in (d) of FIG. 3B.

Meanwhile, conventionally, during the set-down period, wall charges accumulated between the scan electrode Y and the address electrode X during the set-up period are erased and wall charges accumulated between the scan electrode Y and the sustain electrode Z remain.

Also, conventionally, if each cell of Red (R), Green(G), or Blue (B) forms a unit pixel and at least one cell of unit pixels is continuously in a turned-off state when a plasma display panel is driven, charged particles in neighboring cells are diffused to the cell which is continuously in the turned-off state. In this case, the unit pixel forms a single color pattern on a displayed screen.

The cell which is continuously in the turned-off state should not be turned on when the unit pixel forms the single color pattern. However, during the address period, a wrong discharge is generated between the scan electrode Y and the sustain electrode Z by the wall charges fixed during the set-down period and the charged particles diffused from the neighboring cells. This is called an “afterimage-generating wrong discharge”. In the conventional plasma display apparatus, since an afterimage-generating wrong discharge caused during an address period influences the following sustain period, a sustain discharge is maintained and thus spots are created.

### SUMMARY OF THE INVENTION

Accordingly, an object of the present invention is to solve at least the problems and disadvantages of the background art.

The present invention provides a plasma display apparatus which is capable of preventing an afterimage-generating wrong discharge.

The present invention also provides a plasma display apparatus which is capable of preventing spots from being created on a displayed single color pattern.

The present invention also provides a plasma display apparatus which is capable of preventing screen distortion from occurring due to applied pulses.

According to an aspect of the present invention, there is provided a plasma display apparatus including: a plasma display panel on which a plurality of sustain electrode pairs, each including a scan electrode and a sustain electrode, are formed; a driver driving each sustain electrode pair; and a driving pulse controller which controls the driver to sequentially apply a first falling waveform and a second falling waveform to the scan electrode and to apply a positive waveform to the sustain electrode while applying the first falling waveform, in a reset period.

According to another aspect of the present invention, there is provided a plasma display apparatus including: a plasma display panel on which a plurality of sustain electrode pairs, each including a scan electrode and a sustain electrode, are formed; a driver driving each sustain electrode pair; and a driving pulse controller which controls the driver to sequentially apply a first falling waveform and a second falling waveform falling from the same voltage level as the first falling waveform to the scan electrode and to apply a positive waveform to the sustain electrode while applying the first falling waveform, in a reset period.

According to another aspect of the present invention, there is provided a plasma display apparatus including: a plasma display panel on which a plurality of sustain electrode pairs, each including a scan electrode and a sustain electrode, are formed; a driver driving each sustain electrode pair; and a driving pulse controller which controls the driver to apply a first falling waveform falling from a first voltage level lower than the maximum voltage level of a set-up waveform and then apply a second falling waveform falling from a second voltage level lower than the first voltage level to the scan electrode, and to apply a positive waveform to the sustain electrode while applying the first falling waveform, in a reset period.

According to another aspect of the present invention, there is provided a plasma display apparatus including: a plasma display panel having a plurality of sustain electrode pairs, each including a scan electrode and a sustain electrode; a driver driving each sustain electrode pair; and a driving pulse controller which controls the driver to apply a first falling waveform and a second falling waveform whose minimum voltage levels are negative to the scan electrode, to apply a positive waveform to the sustain electrode while applying the first falling waveform and to apply a ground voltage GND to the sustain electride while applying the second falling waveform, in a reset period.

According to another aspect of the present invention, there is provided a driving method of a plasma display apparatus, in which discharge cells are formed by a plurality of sustain electrode pairs, each including a scan electrode and a sustain electrode, and a plurality of address electrodes intersecting the plurality of sustain electrode pairs, the driving method including: (a) applying a set-up waveform to the scan electrode; (b) applying a first falling waveform whose minimum voltage level is negative to the scan electrode and applying a positive waveform to the sustain electrode while the first falling waveform is applied; and (c) applying a second falling waveform whose minimum voltage level is negative to the scan electrode.

Therefore, it is possible to suppress the occurrence of an afterimage-generating wrong discharge.

Also, according to the present invention, it is possible to prevent spots from appearing in a displayed single color pattern.

Further, according to the present invention, it is possible to prevent screen distortion from being generated.

Furthermore, according to the present invention, it is possible to prevent a complementary color afterimage from appearing on a displayed image.

### BRIEF DESCRIPTION OF THE DRAWINGS

The invention will be described in detail with reference to the following drawings in which like numerals refer to like elements.

FIG. 1 is a perspective view of a conventional plasma display panel.

FIG. 2 is a view for explaining an image forming method used in the conventional plasma display apparatus.

FIG. 3A shows timing diagrams illustrating driving waveforms which is used in the conventional plasma display apparatus.

FIG. 3B is a view for explaining wall charge distributions of discharge cells by the conventional driving waveforms illustrated in FIG. 3A.

FIG. 4 is a view for explaining the structure of a plasma display apparatus according to a first embodiment of the present invention.

FIG. 5A shows timing diagrams of driving waveforms used in the plasma display apparatus according to the first embodiment of the present invention.

FIG. 5B is a view for explaining wall charge distributions of discharge cells by the driving waveforms illustrated in FIG. 5A.

FIG. 6 shows waveforms for explaining a relationship between a set-up waveform and a first falling waveform used in the plasma display apparatus according to the first embodiment of the present invention.

FIG. 7 shows modified waveforms which are used in the plasma display apparatus according to the first embodiment of the present invention.

FIG. 8 shows timing diagrams for explaining a waveform including a pre-reset pulse which is used in the plasma display apparatus according to the first embodiment of the present invention.

FIG. 9 is a view for explaining the structure of a plasma display apparatus according to a second embodiment of the present invention.

FIG. 10 shows timing diagrams of driving waveforms which are used in the plasma display apparatus according to the second embodiment of the present invention.

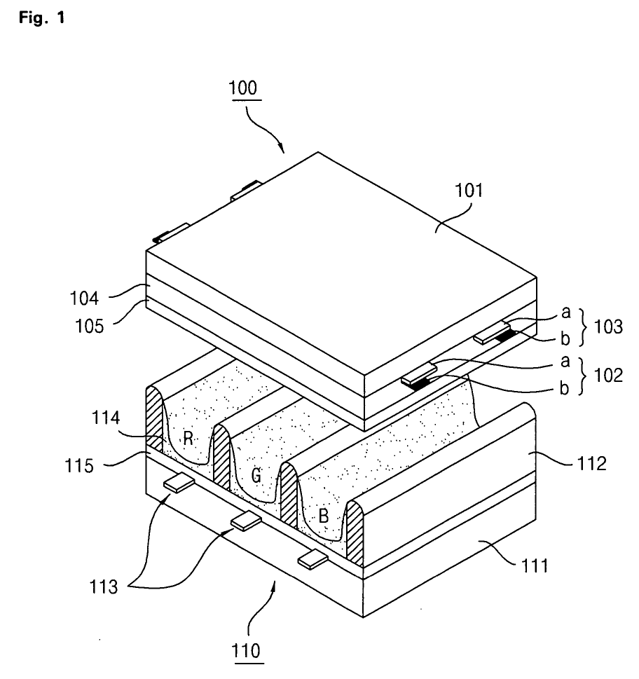

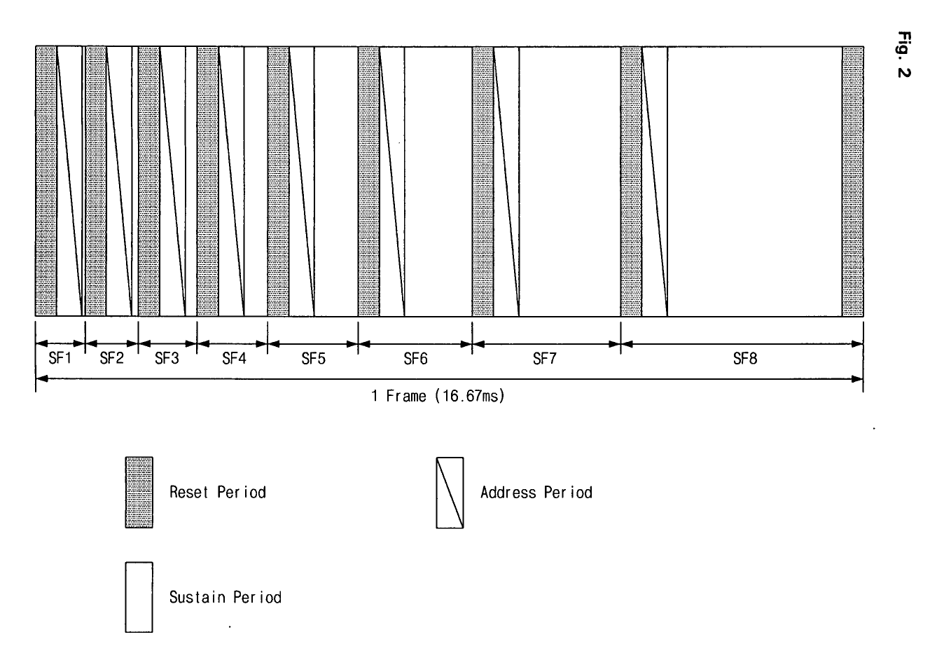

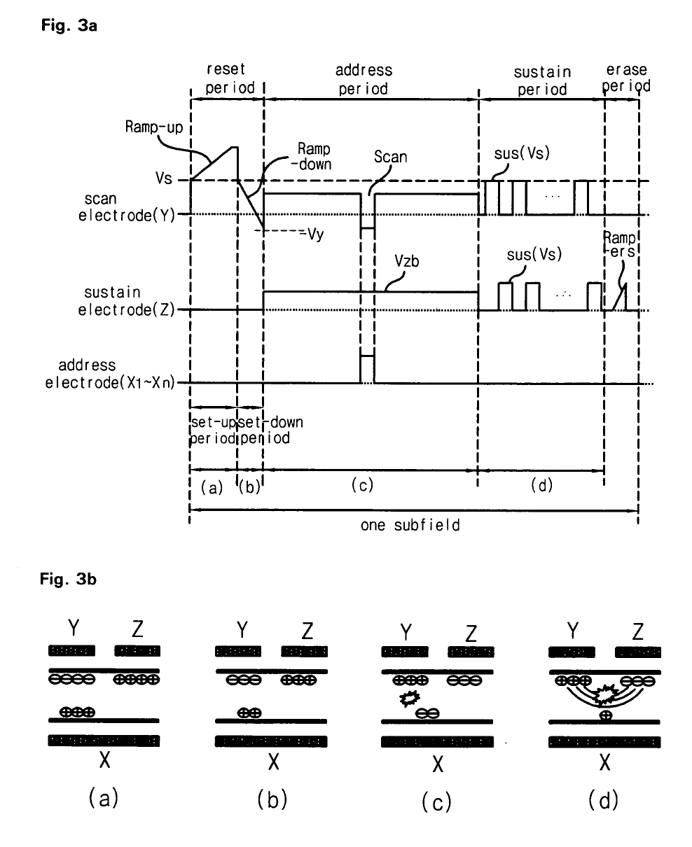

### DETAILED DESCRIPTION OF PREFERRED EMBODIMENTS

Preferred embodiments of the present invention will be described in a more detailed manner with reference to the drawings.

According to an aspect of the present invention, there is provided a plasma display apparatus including: a plasma display panel on which a plurality of sustain electrode pairs, each including a scan electrode and a sustain electrode, are formed; a driver driving each sustain electrode pair; and a driving pulse controller which controls the driver to sequentially apply a first falling waveform and a second falling waveform to the scan electrode and to apply a positive waveform to the sustain electrode while applying the first falling waveform, in a reset period.

The positive waveform has the same voltage level as a sustain waveform which is applied to the sustain electrode.

The minimum voltage levels of the first and second falling waveforms are negative.

The minimum voltage level of the first falling waveform is different from that of the second falling waveform.

The minimum voltage level of the first falling waveform is higher than that of the second falling waveform.

The absolute value of the minimum voltage level of the first falling waveform is equal to or smaller than 30% of the absolute value of the minimum voltage level of the second falling waveform.

In the reset period, the minimum voltage level of the first falling waveform is controlled according to the maximum voltage level of a set-up waveform which is applied to the scan electrode.

The minimum voltage level of the first falling waveform is between −50 Volt and −10 Volt.

The width of the first falling waveform is between 10 μs and 30 μs.

The first and second falling waveforms are supplied from the same voltage source.

The first falling waveform is applied in at least one subfield period.

Whiel the second falling waveform is applied, the sustain electrode maintains the ground GND level.

Before the reset period, there is a pre-reset period during which a positive waveform is applied to one of the sustain electrode pair and a negative waveform is applied to the other of the sustain electrode pair.

The minimum voltage level of a first falling waveform in a subfield including the pre-reset period is different from that of a first falling waveform in at least one of the remaining subfields.

The maximum voltage level of a set-up waveform in a subfield including the pre-reset period is different from that of a set-up waveform in at least one of the remaining subfields.

According to another aspect of the present invention, there is provided a plasma display apparatus including: a plasma display panel on which a plurality of sustain electrode pairs, each including a scan electrode and a sustain electrode, are formed; a driver driving each sustain electrode pair; and a driving pulse controller which controls the driver to sequentially apply a first falling waveform and a second falling waveform falling from the same voltage level as the first falling waveform to the scan electrode and to apply a positive waveform to the sustain electrode while applying the first falling waveform, in a reset period.

Here, the same voltage level is a ground (GND) voltage.

Furhter, while the secod falling waveform is applied, the sustain electrode maintains the ground GND level.

According to another aspect of the present invention, there is provided a plasma display apparatus including: a plasma display panel on which a plurality of sustain electrode pairs, each including a scan electrode and a sustain electrode, are formed; a driver driving each sustain electrode pair; and a driving pulse controller which controls the driver to sequentially apply a first falling waveform falling from a first voltage level lower than the maximum voltage level of a set-up waveform and then apply a second falling waveform falling from a second voltage level lower than the first voltage level to the scan electrode, and to apply a positive waveform to the sustain electrode while applying the first falling waveform, in a reset period.

Here, the first voltage level has the same voltage level as a scan reference waveform which is applied to the scan electrode.

Further, while the second falling waveform is applied, the sustain electrode the ground GND level.

According to another aspect of the present invention, there is provided a plasma display apparatus including: a plasma display panel on which a plurality of sustain electrode pairs, each including a scan electrode and a sustain electrode, are formed; a driver driving each sustain electrode pair; and a driving pulse controller which controls the driver to apply a first falling waveform and a second falling waveform whose minimum voltage levels are negative to the scan electrode, and to apply a positive waveform to the sustain electrode while applying the first falling waveform, in a reset period.

According to further another aspect of the present invention, there is provided a plasma display apparatus including: a plasma display panel on which a plurality of sustain electrode pairs, each including a scan electrode and a sustain electrode, are formed; a driver driving each sustain electrode pair; and a driving pulse controller which controls the driver to apply a first falling waveform and a second falling waveform whose minimum voltage levels are negative to the scan electrode, to apply a positive waveform to the sustain electrode while applying the first falling waveform and to maintain of the sustain electrode at a ground GND level while applying the second falling waveform, in a reset period.

According to still further another aspect of the present invention, there is provided a driving method of a plasma display apparatus, in which discharge cells are formed by a plurality of sustain electrode pairs, each including a scan electrode and a sustain electrode, and a plurality of address electrodes intersecting the plurality of sustain electrode pairs, the driving method including: (a) applying a set-up waveform to the scan electrode; (b) applying a first falling waveform whose minimum voltage level is negative to the scan electrode and applying a positive waveform to the sustain electrode while the first falling waveform is applied; and (c) applying a second falling waveform whose minimum voltage level is negative to the scan electrode.

Hereinafter, detailed embodiments according to the present invention will be described with reference to the appended drawings.

### First Embodiment

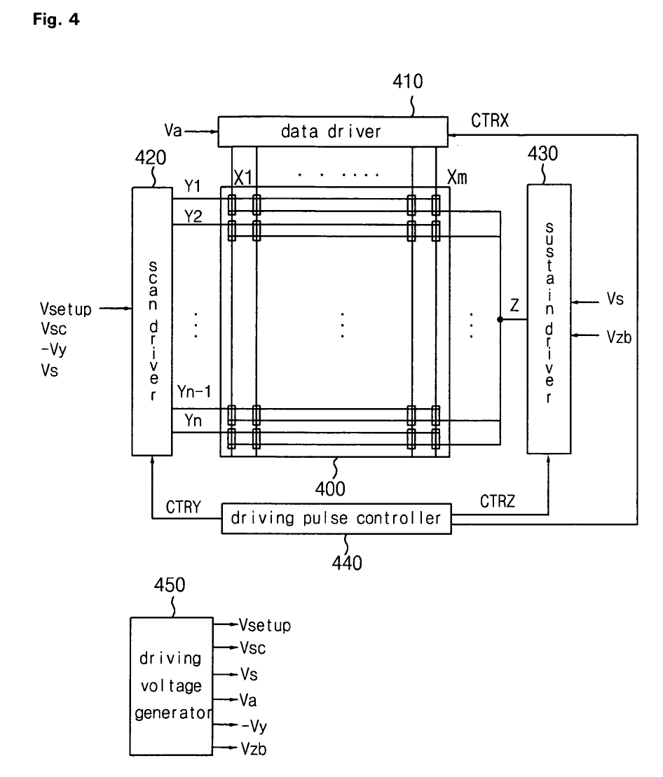

FIG. 4 is a view for explaining the structure of a plasma display apparatus according to a first embodiment of the present invention.

Referring to FIG. 4, the plasma display apparatus according to the first embodiment of the present invention includes a plasma display panel 400, a data driver 410, a scan driver 420, a sustain driver 430, a driving pulse controller 440, and a driving voltage generator 450.

A plurality of scan electrodes Y₁ through Yₙ, a plurality of sustain electrodes Z, and a plurality of address electrodes X₁ through Xₘ which intersect the scan electrodes Y₁ through Yₙ and the sustain electrodes Z, are formed on the plasma display panel 400.

The data driver 410 applies data to the address electrodes X₁ through Xₘ formed on the plasma display panel 400, wherein the data is image signal data obtained by processing an image signal received from the outside in an image signal processor (not shown). The data driver 410 samples and latches data in response to a data timing control signal CTRX received from the driving pulse controller 440 and then supplies an address pulse with an address voltage Va to the respective address electrodes X₁ through Xₘ.

The scan driver 420 drives the scan electrodes Y₁ through Yₙ formed on the plasma display panel 400. First, in a reset period, the scan driver 420 supplies a set-up pulse of a rising ramp waveform obtained from a combination of a sustain voltage Vₛ and a set-up voltage Vₛₑₜᵤₚ to the scan electrodes Y₁ through Yₙ under the control of the driving pulse controller 440.

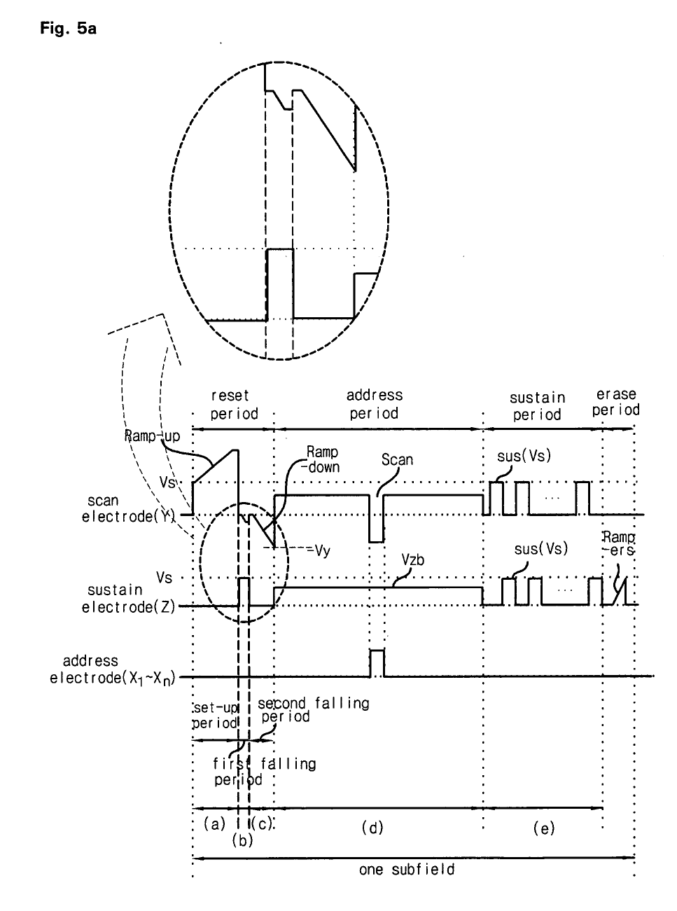

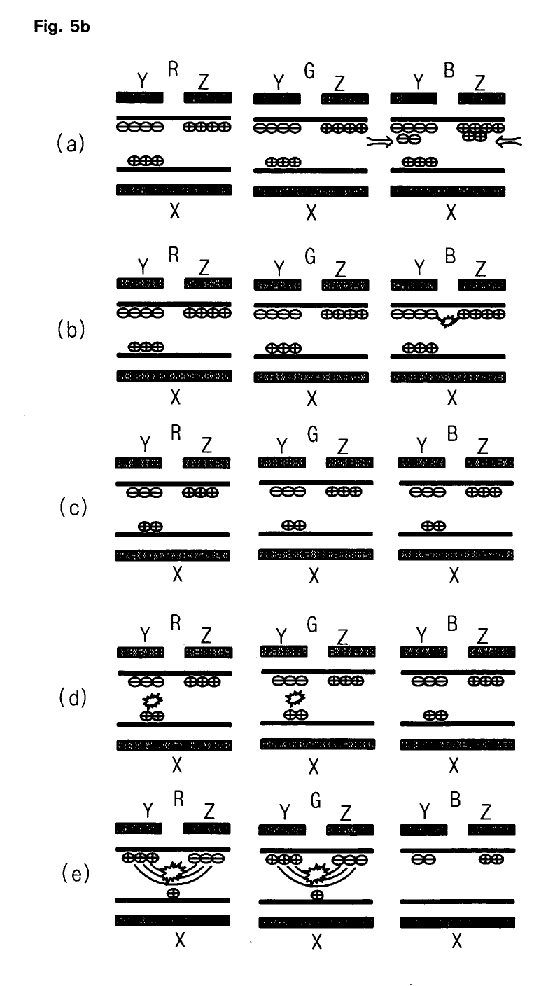

Also, the scan driver 420 supplies a first falling pulse and a second falling pulse which fall to negative voltage levels to the scan electrodes Y₁ through Yₙ. Here, the second falling pulse is equal to the conventional set-down pulse. That is, after the set-up pulse is supplied, wall charges in all discharge cells are uniformly erased. According to the first embodiment of the present invention, before the second falling pulse is supplied, a predetermined falling pulse, that is, the first falling pulse is supplied to the scan electrodes Y₁ through Yₙ. The first falling pulse is used for erasing wall charges fixed on the scan electrodes Y₁ through Yₙ and sustain electrodes Z of cells which are continuously in a turned-off state. In order to partially erase the wall charges, while the first falling pulse is applied, the sustain driver 430 supplies a positive pulse to the sustain electrodes Z. This process will be described later with reference to FIGS. 5A through 8.

Thereafter, in an address period, a scan pulse changing from a scan reference voltage V_{sc} to a scan voltage −V_{y} is applied sequentially to the respective scan electrodes Y₁ through Yₙ. Then, in a sustain period, the scan driver 420 supplies at least one sustain pulse swinging between the ground (GND) voltage and the sustain voltage Vₛ to the scan electrodes Y₁ through Yₙ in order to perform a sustain discharge.

The sustain driver 430 drives the sustain electrodes Z formed as common electrodes on the plasma display panel 400. The sustain driver 430 of the plasma display apparatus according to the first embodiment of the present invention supplies a positive pulse to the sustain electrodes Z while the first falling pulse is applied to the scan electrodes Y₁ through Yₙ, under the control of the driving pulse controller 440. Also, in the address period, a bias voltage V_{zb} is supplied to the sustain electrodes Z, and, in the sustain period, at least one sustain pulse swinging between the ground (GND) voltage to the sustain voltage Vₛ is supplied to the sustain electrodes Z in order to perform a sustain discharge.

The driving pulse controller 440 controls the data driver 410, the scan driver 420, and the sustain driver 430 when the plasma display panel 400 is driven. That is, the driving pulse controller 440 generates timing control signals CTRX, CTRY, and CTRZ for controlling the operation timing and synchronization of the data driver 410, the scan driver 420, and the sustain driver 430 in the reset period, the address period, and the sustain period as described above, and transmits the respective timing control signals CTRX, CTRY, and CTRZ to the respective drivers 410, 420, and 430.

Here, the data control signal CTRX includes a sampling clock signal for sampling data, a latch control signal, and a switch control signal for controlling the on/off time of an energy recovery circuit and a driving switch device included in the data driver 410. The scan control signal CTRY includes a switch control signal for controlling the on/off time of an energy recovery circuit and a driving switch device included in the scan driver 420. The sustain control signal CTRZ includes a switch control signal for controlling the on/off time of an energy recovery circuit and a driving switch device included in the sustain driver 430.

The driving voltage generator 450 generates and supplies driving voltages required for the driving pulse controller 440 and the respective drivers 410, 420, and 430. That is, the driving voltage generator 450 generates the set-up voltage Vₛₑₜᵤₚ, the scan reference voltage V_{sc}, the scan voltage −V_{y}, the sustain voltage Vₛ, the address voltage Vₐ, and the bias voltage V_{zb}. These driving voltages can be adjusted according to the composition of discharge gas or the structure of discharge cells. Now, driving waveforms and wall charge distribution in the plasma display panel, which are implemented by the plasma display apparatus according to the first embodiment of the present invention, will be described with reference to FIGS. 5A and 5B.

FIG. 5A shows timing diagrams of driving waveforms which are used in the plasma display apparatus according to the first embodiment of the present invention.

As shown in FIG. 5A, the plasma display apparatus according to the first embodiment of the present invention is driven according to a reset period for initializing all cells, an address period for selecting cells to be discharged, a sustain period for maintaining the discharge of the selected cells, and an erase period for erasing wall charges in the discharged cells.

In the reset period, during a set-up period, a set-up waveform of a rising ramp pulse is applied simultaneously to all scan electrodes. Thus, a weak dark discharge (set-up discharge) occurs in all discharge cells on the entire screen by the set-up waveform. Due to the set-up discharge, positive wall charges are accumulated on address electrodes and sustain electrodes and negative wall charges are accumulated on the scan electrodes.

According to the first embodiment of the present invention, in order to prevent an afterimage-generating wrong discharge from occurring, the wall charges formed between the scan electrodes and the sustain electrodes are selectively erased. In order to perform this process, the set-up waveform is supplied to the scan electrodes during the set-up period and then a first falling waveform with negative polarity gradually falling from a ground (GND) voltage is applied to the scan electrodes. At this time, a positive waveform is applied to the sustain electrodes in synchronization with the first falling waveform, so that a weak erase discharge occurs between the scan electrodes and the sustain electrodes.

Due to the erase discharge, the plasma display apparatus selectively erases wall charges excessively accumulated on cells which are continuously in a turned-off state. Therefore, it is possible to suppress the occurrence of a wrong discharge and thus prevent spots from appearing when a single color pattern is implemented.

The first falling waveform falls from the ground (GND) voltage to a minimum voltage level which is higher than −50 Volt and lower than −10 Volt. If the first falling waveform falls lower than the threshold value −50 Volt, the erase discharge is excessively generated between the scan electrodes and the sustain electrodes and a dark afterimage appears by erase light. Also, if the first falling waveform does not fall lower than the threshold value −10 Volt, no erase discharge occurs between the scan electrodes and the sustain electrodes.

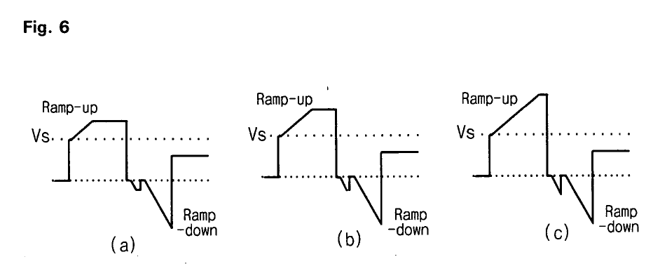

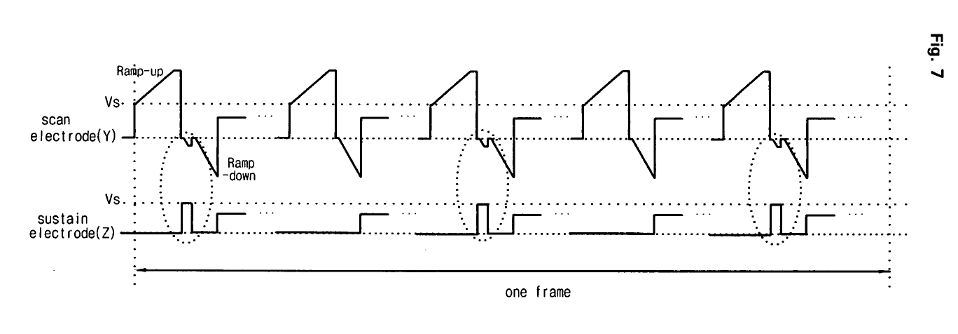

According to the first embodiment of the present invention, the minimum voltage level of the first falling waveform is controlled according to the maximum voltage level of the set-up waveform applied during the set-up period. Since the amount of accumulated wall charges are different according to the maximum voltage level of the set-up waveform, it is possible to control the amount of wall charges to be erased by controlling the minimum voltage level of the first falling waveform. This process will be described in detail later with reference to FIG. 6.

Also, it is preferable that the width of the first falling waveform is between 10 μs and 30 μs in order to ensure a sufficient erase discharge time.

According to the first embodiment of the present invention, since the first and second falling waveforms are created using a voltage supplied from the same voltage source which has been used for supplying the conventional set-down waveform, manufacturing costs required for hardware configuration can be reduced. The first waveform and the second waveform can be created by controlling a switching time of the voltage supplied from the same voltage source.

According to the first embodiment of the present invention, although the first and second falling waveforms are created using a voltage supplied from the same voltage source, the absolute value of the minimum voltage level of the first falling waveform is equal to or smaller than 30% of the absolute value of the minimum voltage level −V_{y} of the second falling waveform.

If the absolute value of the minimum voltage level of the first falling waveform is greater than 30% of the absolute value (about 200) of the minimum voltage level −V_{y} of the second falling waveform, erase light generated by the erase discharge between the scan electrodes and the sustain electrodes increases. Specifically, since a large amount of wall charges are accumulated in cells which are continuously in the turned-off state, the brightness of erase light emitted from the cells becomes higher than that of erase light emitted from different cells. Accordingly, in an image area in which a single color pattern is implemented, a dark afterimage corresponding to a complementary color of the single color appears. This dark afterimage is called a “complementary color afterimage”. According to the first embodiment of the present invention, considering the complementary color afterimage which can appear by the first falling waveform, the absolute value of the minimum voltage level of the first falling waveform is controlled to be equal to or smaller than 30% of the absolute value of the minimum voltage level of the second falling waveform, as described above.

Also, according to the first embodiment of the present invention, the positive waveform applied to the sustain electrodes has the same voltage (Vₛ) level as a sustain waveform applied in the sustain period. Thus, a potential difference is formed between the positive waveform and the first falling waveform applied to the scan electrodes so that an erase discharge is performed. This results in reducing manufacturing costs required for hardware configuration.

During the set-down period, a second falling waveform falling from the ground (GND) voltage to a predetermined voltage (−V_{y}) level whose minimum voltage level is lower than the first falling waveform, is applied. By occurring an erase discharge between the scan electrodes and address electrodes in cells, wall charges formed between the scan electrodes and address electrodes are sufficiently erased. By applying the second falling waveform, the amount of wall charges which is sufficient to stably occur an address discharge remains uniform in the cells. That is, the second falling waveform performs the same function as the conventional set-down waveform.

In an address period, a negative scan waveform is applied sequentially to the scan electrodes and simultaneously a positive address waveform is applied to the address electrodes in synchronization with the scan waveform. A potential difference between the scan waveform and the address waveform is added with the wall voltage created in the reset period, so that an address discharge is generated in cells to which the address waveform is applied. In the cells selected by the address discharge, the amount of wall charges which is sufficient to occur a discharge when a sustain waveform of a sustain voltage Vₛ is applied, is formed. In the address period, in order to reduce a potential difference between the address electrodes and the scan electrodes and thus prevent a wrong discharge from occurring, a positive bias voltage V_{zb} is supplied to the sustain electrodes.

In a sustain period, a positive sustain waveform Sus is applied alternately to the scan electrodes and the sustain electrodes. In the cells selected by the address discharge, the wall voltage in the cells is added with the sustain waveform Sus, so that a sustain discharge, that is, a display discharge is generated between the scan electrodes and the sustain electrodes whenever a sustain waveform Sus is applied.

After the sustain discharge is complete, in an erase period, an erase waveform Ramp-ers having a narrow pulse width and a low voltage level is applied to the sustain electrodes so as to erase wall charges which remain in cells on the entire screen. Now, wall charge distributions of discharge cells by the driving waveforms illustrated in FIG. 5A will be described with reference to FIG. 5B.

FIG. 5B is a view for explaining wall charge distributions of discharge cells by the driving waveforms illustrated in FIG. 5A.

Referring to FIG. 5B, during a set-up period of a reset period, a set-up waveform is applied to a scan electrode Y and a waveform with a voltage relatively lower than the set-up waveform is applied to a sustain electrode Z and an address electrodes X. Accordingly, as shown in (a) of FIG. 5B, negative charged particles are accumulated on the scan electrode Y and positive charged particles are accumulated on the sustain electrode Z and the address electrode X.

The R and G cells of R, G, and B unit pixels shown in FIG. 5B continuously maintain in a turned-on state and the B cell continuously maintains in a turned-off state, thereby implementing a single color pattern. Charged particles in the R and G cells which continuously maintain in the turned-on state are diffused to the B cell which continuously maintains in the turned-off state.

Thereafter, a first falling waveform is supplied to the scan electrode Y and a positive waveform is supplied to the sustain electrode Z during a predetermine period. Accordingly, as shown in (b) of FIG. 5B, an erase discharge is generated between the scan electrode Y and the sustain electrode Z of the B cell in which wall charges are excessively formed.

Then, during a set-down period, a second falling waveform whose minimum voltage level is lower than the first falling waveform is supplied to the scan electrode Y, and a predetermined bias voltage, preferably, a waveform of a ground (GND) voltage is applied and sustained to the sustain electrode Z and the address electrode X. Accordingly, as shown in (c) of FIG. 5B, the wall charges created during the set-up period are partially erased. Through this erase process, wall charge distributions of discharge cells become uniform.

Then, in an address period, an address discharge is generated by a scan waveform supplied to the scan electrode Y and an address waveform supplied to the address electrode X, as shown in (d) of FIG. 5B.

Thereafter, in a sustain period, a sustain waveform is at least once applied alternately to the scan electrode Y and the sustain electrode Z, so that a sustain discharge is generated as shown in (e) of FIG. 5B.

FIG. 6 shows waveforms for explaining a relationship between the set-up waveform and the first falling waveform used in the plasma display apparatus according to the first embodiment of the present invention.

As shown in FIG. 6, according to the first embodiment of the present invention, it is possible to adjust the maximum voltage level of the set-up waveform applied to the scan electrode as necessary. It is also possible to temporally adjust the maximum voltage level of the set-up waveform in a unit of frame, or, more finely, in a unit of subfield. It is also possible to spatially adjust the maximum voltage level of the set-up waveform in a unit of scan electrode line. Here, as the maximum voltage level of the set-up waveform is higher, the amount of wall charges formed in each discharge cell increases and the wall charges are saturated when the amount of wall charge reaches a predetermine amount.

As such, according to the first embodiment of the present invention, the minimum voltage level of the first falling waveform is controlled according to the maximum voltage level of the set-up pulse, since the amount of wall charges increases according to increase in the maximum voltage level of the set-up pulse. As shown in (a) through (c) of FIG. 5B, by reducing the minimum voltage level of the first falling waveform according to increase in the maximum voltage level of the set-up waveform, wall charges between the scan electrode and the sustain electrode are sufficiently erased.

FIG. 7 shows modified waveforms which are used in the plasma display apparatus according to the first embodiment of the present invention.

As shown in FIG. 7, according to the first embodiment of the present invention, a first falling waveform is applied to at least one subfield in a frame. If the first falling waveform is included in all subfields in a frame, it is efficient to suppress the occurrence of an afterimage-generating wrong discharge, but the application durations of different waveforms are relatively reduced due to the temporal limitation of the frame.

For example, if a sustain period for emitting sustain discharge light to be actually displayed is reduced, the brightness of a displayed screen decreases and contrast is lowered. Accordingly, in the first embodiment of the present invention, the number of the first falling waveforms which are applied in a unit of frame is decided considering two aspects of temporal limitation and afterimage-generating wrong discharge prevention.

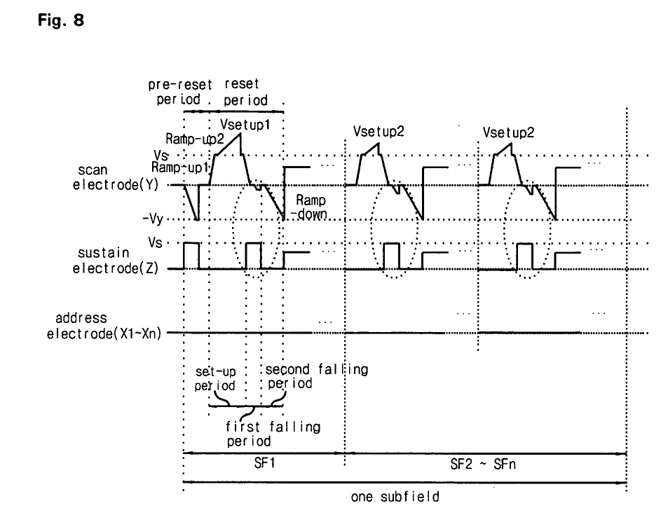

FIG. 8 shows timing diagrams for explaining a waveform including a pre-reset pulse which is used in the plasma display apparatus according to the first embodiment of the present invention.

As shown in FIG. 8, the modified waveforms which are used in the plasma display apparatus according to the first embodiment of the present invention include a pre-reset period in which a positive waveform is applied to one of a sustain electrode pair and a negative waveform is applied to the other of the sustain electrode pair, before a reset period.

For example, during the pre-reset period, a gradually falling negative waveform is applied to scan electrodes and a positive waveform of a sustain voltage Vₛ is applied to sustain electrodes. Also, a ground (GND) voltage (0 Volt) is applied to address electrodes. At this time, in all discharge cells, a dark discharge occurs between the scan electrodes and sustain electrodes and between the sustain electrodes and address electrodes, so that wall charges are formed.

Since the pre-reset waveform is applied before a reset period of an initial subfield for each frame, all discharge cells have the same wall charge distribution and are initialized. By ensuring stable wall charge distribution through the pre-set period, it is possible to reduce the maximum voltage level of a set-up waveform of each of subfields in a frame. Also, the reduction in the maximum voltage level of the set-up waveform leads to reduction of a set-up period, thereby ensuring a sufficient driving margin.

During the set-up period of the reset-period, a first positive ramp waveform Ramp-up 1 and a second positive ramp waveform Ramp-up 2 are successively applied to the scan electrodes and 0 Volt is applied to the sustain electrodes and the address electrodes. The voltage of the first positive ramp waveform Ramp-up 1 rises from 0 Volt to a positive sustain voltage Vₛ and the voltage of the second positive ramp waveform Ramp-up 2 rises from the positive sustain voltage Vₛ to a maximum voltage Vₛₑₜᵤₚ 1 or Vₛₑₜᵤₚ 2 higher than the positive sustain voltage Vs. By the set-up period, wall charges are accumulated in all discharge cells.

Here, according to the first embodiment of the present invention, the maximum voltage level Vₛₑₜᵤₚ 1 of a set-up waveform of a first subfield SF1 applied to the scan electrodes is different from the maximum voltage level Vₛₑₜᵤₚ 2 of set-up waveforms of the remaining subfields SF2 through SFn. Preferably, the maximum voltage level Vₛₑₜᵤₚ 1 of the first subfield SF1 is set higher than the maximum voltage level Vₛₑₜᵤₚ 1 of the remaining subfields SF2 through SFn. This is because wall charge distributions of all discharge cells are initialized during the pre-reset period. Accordingly, in a first subfield SF1 following a pre-reset period, the maximum voltage level of a set-up waveform is set higher than the maximum voltage levels of set-up waveforms of the remaining subfields SF2 through SFn, in order to obtain the same wall charge distribution as the remaining subfields SF2 through SFn.

After the set-up period, a first negative falling waveform which falls to the ground (GND) voltage lower than the maximum voltage level of the set-up waveform and then gradually rises, is applied to the scan electrodes, and a positive waveform is applied to the sustain electrodes Z in synchronization with the first falling waveform, so that a weak erase discharge occurs between the scan electrodes and the sustain electrodes.

According to the first embodiment of the present invention, in the driving waveform including the pre-reset period, the minimum voltage level of the first falling waveform of the first subfield SF1 is different from the minimum voltage levels of the first falling waveforms of the remaining subfields SF2 through SFn. Due to the pre-reset waveform, wall charges formed after the set-up period in the first subfield SF1 are less than all charges formed after the set-up periods of the remaining subfields SF2 through SFn. This is because a certain amount of wall charges has been formed in advance in the remaining subfields SF2 through SFn. That is, the first subfield SF1 controls the first falling pulse to generate a weak erase discharge and the remaining subfields SF2 through SFn control the first falling waveform to generate an erase discharge stronger than in the first subfield SF1.

Preferably, the minimum voltage level of the first falling waveform of the first subfield SF1 is between −20 Volt and −10 Volt and the minimum voltage levels of the first falling waveforms of the remaining subfields SF2 through SFn are between −50 Volt and −10 Volt.

If the first falling waveform falls lower than the threshold value −20 Volt in the first subfield SF1 or lower than the threshold value −50 Volt in the remaining subfields SF2 through SFn, an erase discharge is excessively generated between the scan electrodes and the sustain electrodes and a dark afterimage appears. Also, if the first falling waveform does not fall lower than −10 Volt, no erase discharge occurs between the scan electrodes and the sustain electrodes.

Also, in order to ensure an appropriate erase discharge period, preferably, the width of the first falling waveform of the first subfield SF1 is between 10 μs and 30 μs and the width of each of the first falling waveforms of the remaining subfields SF2 through SFn is between 20 μs and 30 μs.

A set-down period, an address period, and a sustain period have been described above with reference to FIG. 5A, and therefore detailed descriptions thereof are omitted.

As such, by selectively erasing wall charges excessively accumulated on cells which are continuously in a turned-off state in an area displaying a single color pattern when the plasma display panel is driven, using the first falling waveform, it is possible to more efficiently improve a spot problem. Further, by limiting the minimum voltage level of the first falling waveform, it is possible to in advance prevent a complementary color afterimage from being generated.

### Second Embodiment

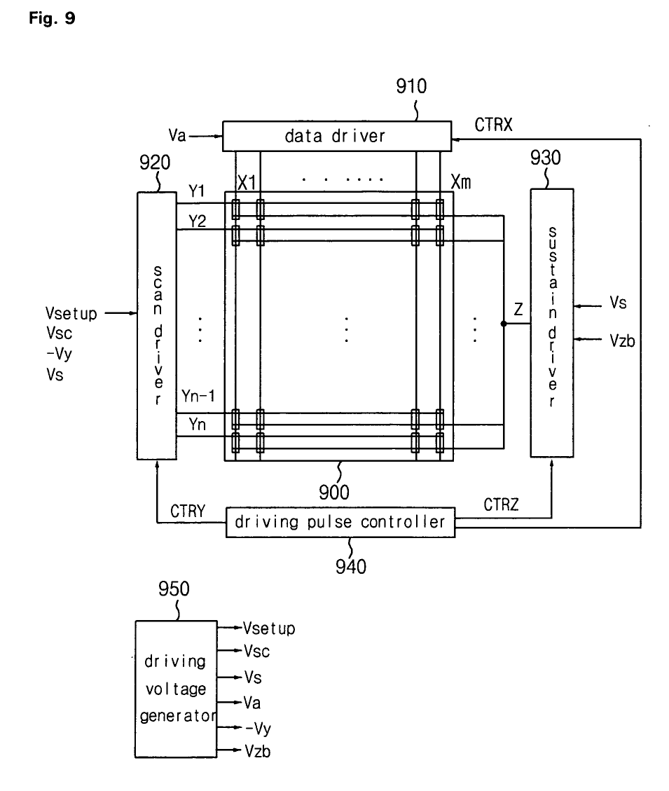

FIG. 9 is a view for explaining the structure of a plasma display apparatus according to a second embodiment of the present invention.

As shown in FIG. 9, the plasma display apparatus according to the second embodiment of the present invention includes a plasma display panel 900, a data driver 910, a scan driver 920, a sustain driver 930, a driving pulse controller 940, and a driving voltage generator 950.

A plurality of scan electrodes Y₁ through Yₙ, a plurality of sustain electrodes Z, and a plurality of address electrodes X₁ through Xₘ which intersect the scan electrodes Y₁ through Y₁ and the sustain electrodes Z, are formed on the plasma display panel 900.

The data driver 910 applies data to the address electrodes X₁ through Xₘ formed on the plasma display panel 900, wherein the data is image signal data obtained by processing an image signal received from the outside in an image signal processor (not shown). The data driver 910 samples and latches data in response to a data timing control signal CTRX received from the driving pulse controller 940 and then supplies an address pulse with an address voltage Va to the respective address electrodes X₁ through Xₘ.

The scan driver 920 drives the scan electrodes Y₁ through Yₙ formed on the plasma display panel 900. First, in a reset period, the scan driver 920 supplies a set-up pulse of a ramp waveform obtained from a combination of a sustain voltage Vₛ and a set-up voltage Vₛₑₜᵤₚ applied from the driving voltage generator 950 to the scan electrodes Y₁ through Yₙ under the control of the driving pulse controller 940.

Also, the scan driver 920 supplies a first falling pulse and a second falling pulse which fall to negative voltage levels to the scan electrodes Y₁ through Yₙ. Here, the second falling pulse is equal to the conventional set-down pulse. That is, after a set-up pulse is supplied, wall charges in all discharge cells are uniformly erased. That is, after a set-up pulse is supplied, wall charges in all discharge cells are uniformly erased. According to the second embodiment of the present invention, before the second falling pulse is supplied, a predetermined falling pulse, that is, the first falling pulse is supplied to the scan electrodes Y₁ through Yₙ. The first falling pulse is used for erasing wall charges fixed on the scan electrodes Y₁ through Yₙ and sustain electrodes Z of cells which are continuously in a turned-off state. In order to partially erase the wall charges, while the first falling pulse is applied, the sustain driver 930 supplies a positive pulse to the sustain electrodes Z.

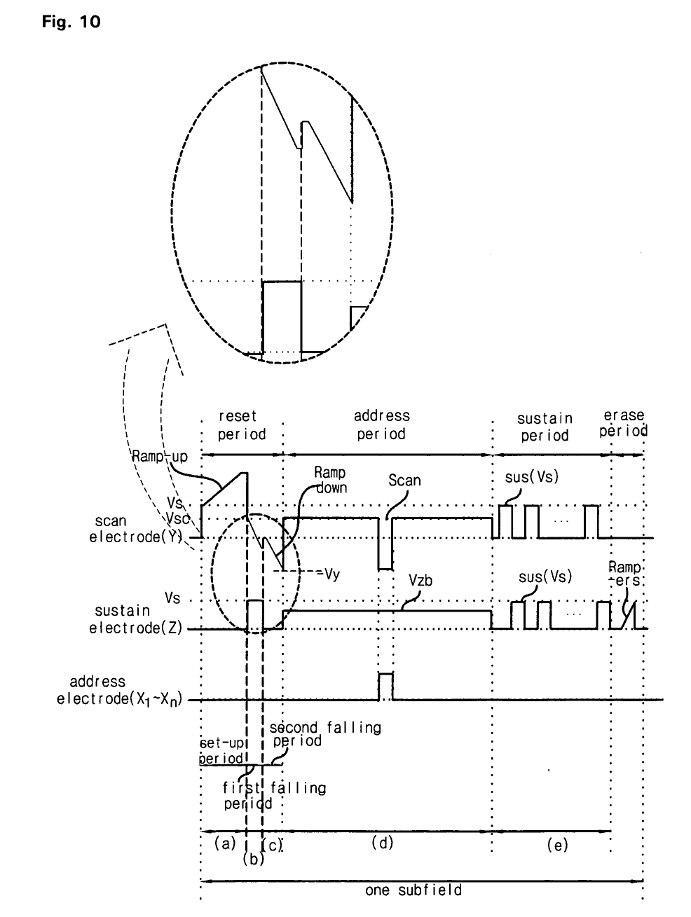

According to the second embodiment of the present invention, the first falling pulse falls from a first voltage level lower than the maximum voltage level of the set-up pulse, and the second falling pulse falls from a second voltage level lower than the first voltage level. The first voltage level is equal to a voltage level V_{sc} of a scan reference waveform which is applied to the scan electrodes Y₁ through Yₙ in a scan period and the second voltage level is a ground (GND) voltage. A detailed description for this will be given later with reference to FIG. 10.

Thereafter, in an address period, a scan pulse changing from the scan reference voltage V_{sc} to a scan voltage −V_{y} is applied sequentially to the respective scan electrodes Y₁ through Yₙ. Then, in a sustain period, the scan driver 920 supplies at least one sustain pulse swinging between the ground (GND) voltage and the sustain voltage Vₛ to the scan electrodes Y₁ through Yₙ in order to perform a sustain discharge.

The sustain driver 930 drives the sustain electrodes Z formed as common electrodes on the plasma display panel 900. The sustain driver 930 of the plasma display apparatus according to the second embodiment of the present invention supplies a positive pulse with the same voltage Vₛ as the sustain pulse to the sustain electrodes Z while the first falling pulse is applied to the scan electrodes Y₁ through Yₙ, under the control of the driving pulse controller 940. Also, in the address period, a bias voltage V_{zb} is supplied to the sustain electrodes Z, and, in the sustain period, at least one sustain pulse swinging between the ground (GND) voltage to the sustain voltage Vₛ is supplied to the sustain electrodes Z in order to perform a sustain discharge.

The driving pulse controller 940 controls the data driver 910, the scan driver 920, and the sustain driver 930 when the plasma display panel 900 is driven. That is, the driving pulse controller 940 generates timing control signals CTRX, CTRY, and CTRZ for controlling the operation timing and synchronization of the data driver 910, the scan driver 920, and the sustain driver 930 in the reset period, the address period, and the sustain period as described above, and transmits the respective timing control signals CTRX, CTRY, and CTRZ to the respective drivers 910, 920, and 930.

Here, the data control signal CTRX includes a sampling clock signal for sampling data, a latch control signal, and a switch control signal for controlling the on/off time of an energy recovery circuit and a driving switch device included in the data driver 910. The scan control signal CTRY includes a switch control signal for controlling the on/off time of an energy recovery circuit and a driving switch device included in the scan driver 920. The sustain control signal CTRZ includes a switch control signal for controlling the on/off time of an energy recovery circuit and a driving switch device included in the sustain driver 930.

The driving voltage generator 950 generates and supplies driving voltages required for the driving pulse controller 940 and the respective drivers 910, 920, and 930. That is, the driving voltage generator 950 generates the set-up voltage Vₛₑₜᵤₚ, the scan reference voltage V_{sc}, the scan voltage −V_{y}, the sustain voltage Vₛ, the address voltage Vₐ, and the bias voltage V_{zb}. These driving voltages can be adjusted according to the composition of discharge gas or the structure of discharge cells. Now, driving waveforms which are implemented by the plasma display apparatus according to the second embodiment of the present invention, will be described with reference to FIG. 10.

FIG. 10 shows timing diagrams of driving waveforms which are used in the plasma display apparatus according to the second embodiment of the present invention.

As shown in FIG. 10, the plasma display apparatus according to the second embodiment of the present invention is driven according to a reset period for initializing all cells, an address period for selecting cells to be discharged, a sustain period for maintaining the discharge of the selected cells, and an erase period for erasing wall charges in the discharged cells.

In the reset period, a set-up waveform of a rising ramp pulse is applied simultaneously to all scan electrodes during a set-up period. Thus, a weak dark discharge (set-up discharge) occurs in discharge cells on the entire screen by the set-up waveform. Due to the set-up discharge, positive wall charges are accumulated on address electrodes and sustain electrodes and negative wall charges are accumulated on scan electrodes.

According to the second embodiment of the present invention, in order to prevent an afterimage-generating wrong discharge from occurring, wall charges formed between the scan electrodes and the sustain electrodes are selectively erased. In order to perform this process, during the set-up period, a rising ramp waveform is supplied and then a first falling waveform falling from a first voltage level lower than the maximum voltage level of the set-up waveform to a predetermined negative voltage level is supplied to the scan electrodes, and a positive waveform is applied to the sustain electrodes in synchronization with the first falling waveform, so that a weak erase discharge occurs between the scan electrodes and the sustain electrodes.

Due to the erase discharge, the plasma display apparatus selectively erases wall charges excessively accumulated in cells which are continuously in a turned-off state. Accordingly, it is possible to suppress the occurrence of a wrong discharge and prevent spots from appearing when a single color pattern is implemented.

Meanwhile, if a positive waveform with a high voltage level, for example, a positive waveform with a sustain voltage Vₛ is applied to the sustain electrodes in order to erase fixed wall charge, a strong discharge can be generated due to the excessive wall charges formed during the set-up period. The strong discharge influences the following sustain discharge and can cause screen distortion. Considering this problem, according to the second embodiment of the present invention, the first falling waveform has a waveform gradually falling from a first positive voltage level. That is, when the first falling pulse is applied, since the scan electrodes have the potential of the first positive voltage level and the sustain electrodes have the potential of the sustain voltage level, a potential difference between the scan electrodes and the sustain electrodes is not large and accordingly the occurrence of strong discharge can be suppressed.

According to the second embodiment of the present invention, the first voltage level is lower than the maximum voltage level of the set-up waveform. Preferably, the first voltage level is equal to the scan reference voltage V_{sc} which is applied in the scan period. Accordingly, it is possible to suppress the occurrence of strong discharge and also reduce manufacturing costs required for hardware configuration. Also, since an appropriate potential difference is formed between the first falling waveform and the positive waveform applied to the sustain electrodes, wall charges are erased while the first falling waveform is applied. Here, the first voltage level, that is, the scan reference voltage V_{sc} is between 10 Volt and 130 Volt.

Also, according to the second embodiment of the present invention, due to the first falling waveform falling from the first positive voltage level as described above, a sustain voltage Vₛ with a high voltage level can be used as a positive waveform to be applied to the sustain electrodes, in order to stably erase wall charges. By using the same voltage Vₛ as the sustain waveform to form an appropriate potential difference between the first falling waveform and the voltage Vₛ, which allows an erase discharge, it is possible to reduce manufacturing costs required for hardware configuration. Also, in actual circuit configuration, since an energy recovery circuit is provided in a sustain voltage applying terminal, it is possible to reduce Electromagnetic Interference (EMI) which is generated when the plasma display panel is driven and minimize the peaking components of positive waveforms.

The negative minimum voltage level of the first falling waveform is between −50 Volt and −10 Volt. If the first falling waveform falls lower than the threshold value −50 Volt, an erase discharge is excessively generated between the scan electrodes and the sustain electrodes, which generates a dark afterimage. If the first falling waveform does not fall lower than −10 Volt, the amount of erased wall charges is not sufficient to suppress a wrong discharge between the scan electrodes and the sustain electrode. This is because wall charges are erased at a negative voltage level while the erase discharge begins when the first falling waveform is applied.

In the second embodiment of the present invention, like the first embodiment of the present invention, the negative minimum voltage level of the first falling waveform is controlled according to the maximum voltage level of the set-up waveform applied during the set-up period. The width of the first falling waveform is set between 10 μs and 30 μs in order to ensure a sufficient erase discharge time. Also, the first and second falling waveforms are created using a voltage supplied from the same voltage source. Also, in the second embodiment of the present invention, although the first and second falling waveforms are created using the voltage supplied from the same voltage source, the absolute value of the minimum voltage level of the first falling waveform is equal to or smaller than 30% of the absolute value of the minimum voltage level −V_{y} of the second falling waveform.

Details regarding a set-down period, an address period, a sustain period, a sustain period, and an erase period, according to the second embodiment of the present invention, have been described above in the first embodiment of the present invention, and therefore detailed descriptions thereof are omitted.

As such, by using a first falling waveform to selectively erase wall charges excessively accumulated in cells which are continuously in a turned-off state in an area representing a single color pattern when a plasma display panel is driven, it is possible to efficiently prevent spots from appearing.

Since the first falling waveform has a waveform falling from a positive voltage level, it is possible to suppress the occurrence of strong discharge even when a high voltage is applied to sustain electrodes and to suppress screen distortion of the plasma display panel. Also, by limiting the minimum voltage level of the first falling waveform, it is possible to in advance prevent a complementary color afterimage from being generated.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus, comprising:
a plasma display panel on which a plurality of sustain electrode pairs, each including a scan electrode and a sustain electrode, are formed;
a driver driving each sustain electrode pair; and
a driving pulse controller which controls the driver to sequentially apply a first falling waveform and a second falling waveform to the scan electrode and to apply a positive waveform to the sustain electrode while applying the first falling waveform, in a reset period.

2. The plasma display apparatus according to claim 1, wherein the positive waveform has the same voltage level as a sustain waveform which is applied to the sustain electrode.

3. The plasma display apparatus according to claim 1, wherein the minimum voltage levels of the first and second falling waveforms are negative.

4. The plasma display apparatus according to claim 1, wherein the minimum voltage level of the first falling waveform is different from that of the second falling waveform.

5. The plasma display apparatus according to claim 4, wherein the minimum voltage level of the first falling waveform is higher than that of the second falling waveform.

6. The plasma display apparatus according to claim 5, wherein the absolute value of the minimum voltage level of the first falling waveform is equal to or smaller than 30% of the absolute value of the minimum voltage level of the second falling waveform.

7. The plasma display apparatus according to claim 1, wherein, in the reset period, the minimum voltage level of the first falling waveform is controlled according to the maximum voltage level of a set-up waveform which is applied to the scan electrode.

8. The plasma display apparatus according to claim 1, wherein the minimum voltage level of the first falling waveform is between −50 Volt and −10 Volt.

9. The plasma display apparatus according to claim 1, wherein the width of the first falling waveform is between 10 μs and 30 μs.

10. The plasma display apparatus according to claim 1, wherein the first and second falling waveforms are supplied from the same voltage source.

11. The plasma display apparatus according to claim 1, wherein the first falling waveform is applied in at least one subfield period.

12. The plasma display apparatus according to claim 1, wherein the sustain electrode maintains the ground GND level while the second falling waveform is applied,

13. The plasma display apparatus according to claim 1, wherein before the reset period, there is a pre-reset period during which a positive waveform is applied to one of the sustain electrode pair and a negative waveform is applied to the other of the sustain electrode pair.

14. The plasma display apparatus according to claim 13, wherein the minimum voltage level of a first falling waveform in a subfield including the pre-reset period is different from that of a first falling waveform in at least one of the remaining subfields.

15. The plasma display apparatus according to claim 13, wherein the maximum voltage level of a set-up waveform in a subfield including the pre-reset period is different from that of a set-up waveform in at least one of the remaining subfields.

16. A plasma display apparatus, comprising:
a plasma display panel on which a plurality of sustain electrode pairs, each including a scan electrode and a sustain electrode, are formed;
a driver driving each sustain electrode pair; and
a driving pulse controller which controls the driver to sequentially apply a first falling waveform and a second falling waveform falling from the same voltage level as the first falling waveform to the scan electrode and to apply a positive waveform to the sustain electrode while applying the first falling waveform, in a reset period.

17. The plasma display apparatus according to claim 16, wherein the same voltage level is a ground (GND) voltage.

18. The plasma display apparatus according to claim 16, wherein while the secod falling waveform is applied, the sustain electrode maintains the ground GND level.

19. A plasma display apparatus, comprising:
a plasma display panel on which a plurality of sustain electrode pairs, each including a scan electrode and a sustain electrode, are formed;
a driver driving each sustain electrode pair; and
a driving pulse controller which controls the driver to sequentially apply a first falling waveform falling from a first voltage level lower than the maximum voltage level of a set-up waveform and then apply a second falling waveform falling from a second voltage level lower than the first voltage level to the scan electrode, and to apply a positive waveform to the sustain electrode while applying the first falling waveform, in a reset period.

20. The plasma display apparatus according to claim 19, wherein the first voltage level has the same voltage level as a scan reference waveform which is applied to the scan electrode.

21. The plasma display apparatus according to claim 19, wherein the sustain electrode maintains the ground GND level while the second falling waveform is applied.

22. A plasma display apparatus, comprising:
a plasma display panel on which a plurality of sustain electrode pairs, each including a scan electrode and a sustain electrode, are formed;
a driver driving each sustain electrode pair; and
a driving pulse controller which controls the driver to apply a first falling waveform and a second falling waveform whose minimum voltage levels are negative to the scan electrode, and to apply a positive waveform to the sustain electrode while applying the first falling waveform, in a reset period.

23. A plasma display apparatus, comprising:
a plasma display panel on which a plurality of sustain electrode pairs, each including a scan electrode and a sustain electrode, are formed;
a driver driving each sustain electrode pair; and
a driving pulse controller which controls the driver to apply a first falling waveform and a second falling waveform whose minimum voltage levels are negative to the scan electrode, to apply a positive waveform to the sustain electrode while applying the first falling waveform and to maintain of the sustain electrode at a ground GND level while applying the second falling waveform, in a reset period.

24. A driving method of a plasma display apparatus, in which discharge cells are formed by a plurality of sustain electrode pairs, each including a scan electrode and a sustain electrode, and a plurality of address electrodes intersecting the plurality of sustain electrode pairs, the driving method, comprising the steps of:
(a) applying a set-up waveform to the scan electrode;
(b) applying a first falling waveform whose minimum voltage level is negative to the scan electrode and applying a positive waveform to the sustain electrode while the first falling waveform is applied; and
(c) applying a second falling waveform whose minimum voltage level is negative to the scan electrode.
